(19) United States
(12) Patent Application Publication
(10) Pub. No.: US 2016/0034607 A1
(43) Pub. Date: Feb. 4, 2016

(54) VIDEO-ASSISTED LANDING GUIDANCE SYSTEM AND METHOD

(71) Applicants: Aaron Maestas, McKinney, TX (US); Valeri I. Karlov, Stony Brook, NY (US); John D. Hulsmann, Miller Place, NY (US)

(72) Inventors: Aaron Maestas, McKinney, TX (US); Valeri I. Karlov, Stony Brook, NY (US); John D. Hulsmann, Miller Place, NY (US)

(21) Appl. No.: 14/447,958

(22) Filed: Jul. 31, 2014

(51) Int. Cl. G06F 17/50; H04N 7/18; G06T 7/00; G06F 17/16; G06K 9/52; G06T 7/20; G06F 17/18; G05D 1/10; G06T 7/60

(52) U.S. Cl. CPC G06F 17/5004; G05D 1/101; H04N 7/18; G06T 7/0042; G06T 7/60; G06K 9/52; G06T 7/20; G06F 17/18; G06F 17/16; G06T 2200/04

(57) ABSTRACT

A system and method for aiding landing of an aircraft receives sequential frames of image data of a landing site from an electro-optic sensor on the aircraft; identifies a plurality of features of the landing site in multiple sequential frames of the image data; calculates relative position and distance data between identified features within multiple sequential frames of image data using a local coordinate system within the frames; provides a mathematical 3D model of the landing site in response to the calculated relative position and distance data from the multiple sequential frames; updates the 3D model by repeating the steps of collecting, identifying, and calculating during approach to the landing site by the aircraft; and uses the 3D model from the step of updating for landing the aircraft on the landing site.

### FIELD OF THE INVENTION

The present invention generally relates to video-assisted landing guidance systems, and in particular to such systems which are used in unmanned aircraft.

### BACKGROUND

Unmanned aircraft, or drones, typically use video streams supplied to remote pilots for enabling the pilots to perform flight operations, including landings. Landings can be particularly tricky because of transmission delays in the video stream and the resulting control signals needed for adjustments in the last few seconds of landing. Limited landing areas, such as aircraft carriers and other platforms, stretch the limits of relying on a two dimensional image stream. Poor weather and visibility increase the difficulty exponentially. Additional data readings can be provided, however transmission delay issues still remain. Automated systems might be used, but they can still suffer from delays in collecting and processing information so it can be used for landing.

Accordingly, landing systems for unmanned aircraft could be improved by enabling faster control changes and by using more than simply two-dimensional images.

### SUMMARY OF THE INVENTION

The technology described herein relates to collecting and processing video sensor data of an intended landing location for use in landing an aircraft and systems which perform that function.

The present invention makes use of a stream of video images of a landing site produced during final approach of an aircraft to provide a three-dimensional (3D) mathematical model of the landing site. The 3D model can be used by a remote pilot, thereby providing more than simple two-dimensional images, with the 3D model not being dependent upon clear live images throughout the approach. The 3D model could also be used to provide guidance to an autopilot landing system. All applications of the 3D model can enhance the success of landings in limited landing areas and in poor visibility and poor weather conditions.

One embodiment of the present invention provides an automated method for aiding landing of an aircraft, comprising: receiving sequential frames of image data of a landing site from an electro-optic sensor on the aircraft; identifying a plurality of features of the landing site in multiple sequential frames of the image data; calculating relative position and distance data between identified features within multiple sequential frames of image data using a local coordinate system within the frames; providing a mathematical 3D model of the landing site in response to the calculated relative position and distance data from the multiple sequential frames; updating the 3D model by repeating the steps of collecting, identifying, and calculating during approach to the landing site by the aircraft; and using the 3D model from the step of updating for landing the aircraft on the landing site.

The step of using may include identifying a landing area in a portion of the 3D model of the landing site, and generating signals for enabling control of aircraft flight in response to the updated 3D model and the identified landing area which signals enable the aircraft to land on the identified landing area. The steps of identifying a landing area may use previously known information about the landing site. The method may further comprise receiving azimuth and elevation data of the electro-optic sensor relative to the landing site and using received azimuth and elevation data in the step of calculating relative position and distance data and in the step of generating signals for enabling control of aircraft flight. The landing area may be identified between identified image features. The step of generating signals may provide distance and elevation information between the aircraft and the landing area. The step of generating signals can provide direction and relative velocity information between the aircraft and the landing area.

The method may further comprise using calculated relative position and distance data from multiple sequential frames of image data to determine time remaining for the aircraft to reach the landing area. The method may further comprise measuring relative two dimensional positional movement of identified features between multiple sequential image frames to determine any oscillatory relative movement of the landing site. The received sequential frames of image data may include a relative time of image capture. The aircraft may use geo-location information to initially locate and identify the landing site. The aircraft may use geo-location information to position the aircraft on a final approach path.

The step of receiving may receive sequential frames of image data of a landing site from different angular positions relative to the landing site. The step of providing a mathematical 3D model may comprise constructing a mathematical 3D model of the landing site from the calculated relative position and distance data. The step of updating may be performed periodically during the entire approach to the landing site. The method may include 3D model data being transmitted to a remote pilot during approach to the landing site for enhancing flight control. The step of using may include providing signals to an autopilot control system to enable automated landing of the aircraft.

Another embodiment of the present invention provides a system for aiding landing of an aircraft, comprising: an electro-optic sensor; a processor coupled to receive images from the electro-optic sensor; and a memory, the memory including code representing instructions that when executed cause the processor to: receive sequential frames of image data of a landing site from the electro-optic sensor; identify a plurality of features of the landing site in multiple sequential frames of the image data; calculate relative position and distance data between identified features within multiple sequential frames of image data using a local coordinate system within the frames; provide a mathematical 3D model of the landing site in response to the calculated relative position and distance data from the multiple sequential frames; update the 3D model by repeating the steps of collecting, identifying, and calculating during approach to the landing site; and enable control of the aircraft in response to an updated 3D model of the landing site.

The memory may include code representing instructions which when executed cause the processor to identify a landing area in a portion of the 3D model of the landing site and generate signals for enabling control of aircraft flight in response to the updated 3D model and the identified landing area to enable the aircraft to land on the identified landing area. The memory includes code representing instructions which when executed cause the processor to receive azimuth and elevation data of the electro-optic sensor relative to the landing site and use received azimuth and elevation data in the step of calculating relative position and distance data to generate signals for enabling control of aircraft flight. The memory may include code representing instructions which when executed cause the processor to identify the landing area between identified features of the landing site.

The memory may include code representing instructions which when executed cause the processor to measure relative two dimensional positional movement of identified features between multiple sequential image frames to determine any oscillatory relative movement of the landing site. The memory may include code representing instructions which when executed cause the processor to construct a mathematical 3D model of the landing site from the calculated relative position and distance data. The memory may include code representing instructions which when executed cause the processor to periodically perform the step of updating during the entire approach to the landing site. The memory may include code representing instructions which when executed cause the processor to execute any of the functions of the associated method embodiment.

Other aspects and advantages of the current invention will become apparent from the following detailed description, taken in conjunction with the accompanying drawings, illustrating the principles of the invention by way of example only.

### BRIEF DESCRIPTION OF THE DRAWINGS

The foregoing features of various embodiments of the invention will be more readily understood by reference to the following detailed descriptions in the accompanying drawings.

FIG. 1 is a schematic illustration of a system for aiding landing an aircraft in accordance with an illustrative embodiment of the present invention.

FIG. 2 is a block diagram of a system for aiding landing an aircraft in accordance with an illustrative embodiment.

FIG. 3 is a block diagram of a module for processing features in image frames, according to an illustrative embodiment.

FIG. 4 is a block diagram of a module for estimating positions of features in image frames, according to an illustrative embodiment.

FIG. 5 is a flowchart of a method for landing an aircraft according to an illustrative embodiment.

FIG. 6 is a block diagram of a computing device used with a system for landing an aircraft according to an illustrative embodiment.

FIG. 7A is a simulated image of an aircraft carrier as would be captured from an aircraft on initial landing approach, using an embodiment of the present invention.

FIG. 7B is a simulated image of the aircraft carrier of FIG. 7A as would be captured from an aircraft shortly before landing on the carrier.

FIG. 8 is a simulated image of the carrier of FIGS. 7B and 7B showing highlight lines representing a 3D model of the carrier.

### DETAILED DESCRIPTION OF ILLUSTRATIVE EMBODIMENTS

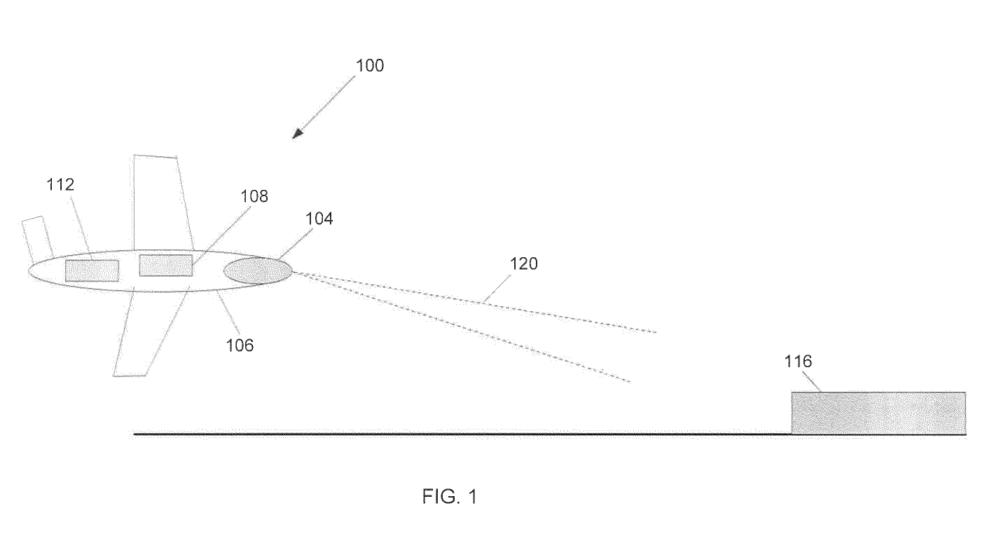

FIG. 1 is a schematic illustration of a system 100 for aiding landing of an aircraft 106 in the field of view 120 of an imaging sensor 104, according to an illustrative embodiment. In addition to imaging sensor 104, the system 100 can optionally include an inertial measurement unit (IMU) 108 that measures the global-frame three-dimensional position, such as the global positioning system (GPS), of the aircraft 106. The system also includes a computing device 112, that includes a processor to process the video data acquired by the imaging sensor 104 as the aircraft 106 approaches a landing site 116, such as an aircraft carrier, located in the field of view 120 of the imaging sensor 104.

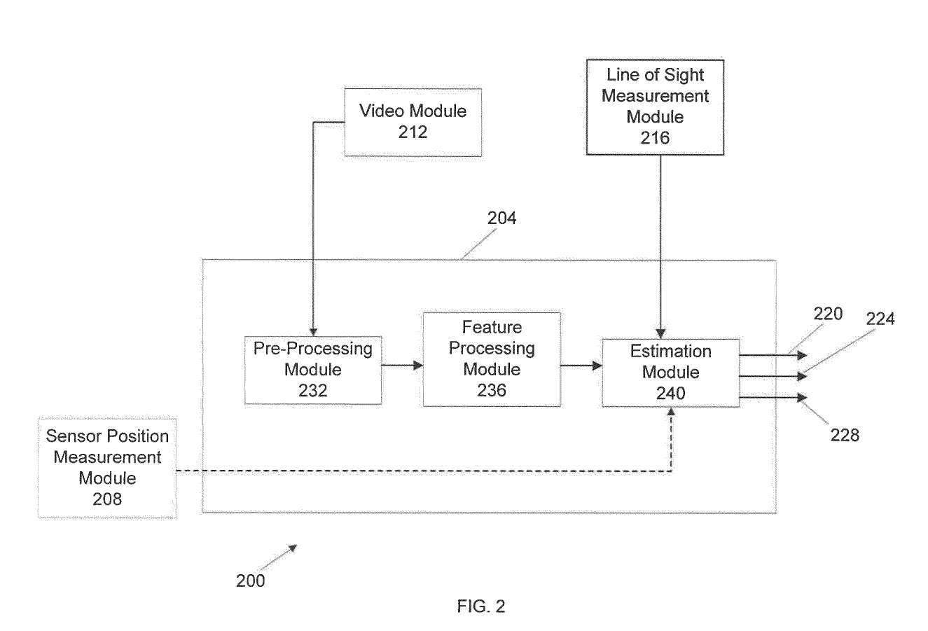

FIG. 2 is a block diagram 200 of a system for aiding landing of an aircraft, as represented in the schematic of FIG. 1. An image processing module 204 receives data from a video module 212, a line of sight measurement module 216, and optionally from a sensor position measurement module 208. Image processing module 204 outputs one or more types of location data (i.e. landing site position data 220, line-of-sight position data 224 to a landing site in the field of view 120 of the imaging sensor 104, and sensor position data 228.

The image processing module 204 includes a pre-processing module 232, a feature processing module 236, and an estimation module 240. The pre-processing module 232 performs image processing techniques (e.g., pixel processing, gain correction) to condition the video data received from the video module 212. The video data is a series of video image frames acquired by and received from the imaging sensor 104. In some embodiments, the image frames are acquired at a fixed rate (e.g., 60 Hz, 120 Hz) capture rate. Each frame is composed of a plurality of pixels (e.g., 1024×1024; 2048×2048; 2048×1024). Each pixel has an intensity value corresponding to the intensity of the image frame at the pixel location. The image frames can be grayscale, color, or any other representation of the electromagnetic spectrum (e.g., infrared, near infrared, x-ray) that the specific imaging sensor is able to acquire. In a preferred embodiment, images are captured in an infrared, electro-optic sensor.

Pre-processing the video data improves the accuracy of the system and reduces its sensitivity to, for example, spurious signals acquired by the imaging sensor 104 or errors in the video data. The pre-processing module 232 can, for example, remove dead pixels or correct signal level/intensity gain for the image frames in the video data. In some embodiments, dead pixels are removed using algorithms that detect and remove outlier pixels. Outlier pixels can be, for example, pixels having intensity values that are very large or very small compared with computed statistics of an image frame or compared with predefined values selected empirically by an operator. In some embodiments, signal level/intensity gain for the image frames is corrected by calibrating the pixel gains in the detector. The pixel gains can be calibrated by moving the focal plane over a uniform background image frame and normalizing the pixel gains by the average value of the pixel signal levels/intensity. The pre-processing module 232 provides the processed video data to the feature processing module 236.

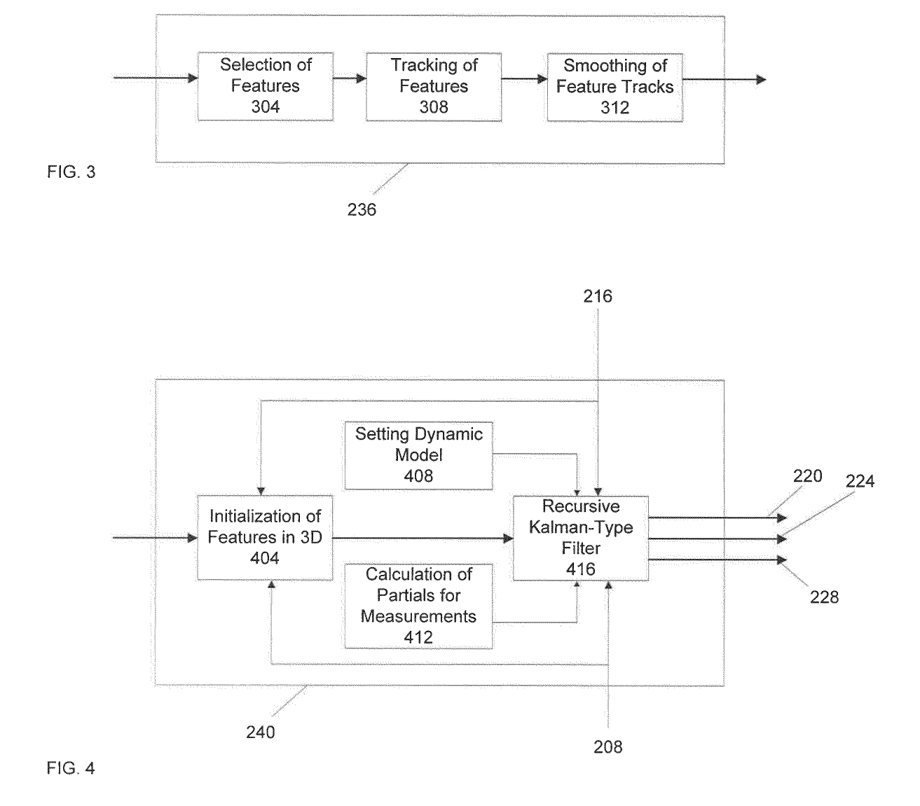

The feature processing module 236 transforms the video data into coordinate values and/or velocity values of features in the image frames of the video data. The feature processing module 236 includes one or more modules to transform the video data prior to providing the video data, position data, and velocity data to the estimation module 240. FIG. 3 is a block diagram of exemplary modules used by feature processing module 236 in some embodiments. The feature processing module 236 includes a module 304 to select features, a module 308 to track the features as a function of time, and a module 312 to smooth the feature tracks to reduce measurement errors.

In some embodiments, the feature processing module 236 automatically selects features in the image frames based on one or more techniques that are known to those skilled in the art. In some embodiments, an operator is provided with the video data to identify features (e.g., by using a mouse to select locations in image frames that the operator wishes to designate as a feature to track). In these later embodiments, the feature processing module 236 uses the operator input to select the features.

In some embodiments, the feature processing module 236 selects features (304) based on, for example, maximum variation of pixel contrast in local portions of an image frame, corner detection methods applied to the image frames, or variance estimation methods. The maximum variation of contrast is useful in identifying corners, small objects, or other features where there is some discontinuity between adjacent pixels, or groups of pixels, in the image frames. While feature selection can be performed with a high level of precision, it is not required. Because the system tracks features from frame to frame as the aircraft approaches the landing site, image definition improves and is cumulatively processed. In applications where the viewing angle of the landing site changes, such as with a rotary wing aircraft or helicopter, which does not depend upon a straight landing approach, there is a small change in viewing angles for practically the same scene conditions, and therefore, the system performance is generally robust to such changes. In some embodiments, some features may not be present or identified in each of the image frames. Some features may be temporarily obscured, or may exit the field of view associated with the image frame. The methods described will start tracking features that come back into the field of view of the system.

Features are defined as a geometric construct of some number of pixels. In some embodiments, a feature is defined as the center of a circle with radius (R) (e.g., some number of pixels, for example, between 1-10 pixels or 1-25 pixels). The center of the feature is then treated as invariant to projective transformation. The radius is adaptive and is chosen as a trade-off between localization-to-point (which is important for estimation of feature position) and expansion-to-area (which is important for registration of the feature in an image). The radius of the feature is usually chosen to be relatively smaller for small leaning or angled features because the features move due to three-dimensional mapping effects and it is often beneficial to separate them from the stationary background. Each feature's pixels are weighted by a Gaussian to allow for a smooth decay of the feature to its boundary. The identified features have locations which are recorded in the two dimensional or local coordinate system of each frame.

Any suitable features may be used depending upon the application and location. Features may also be natural, man-made or even intentional, such as landing lights or heat sources in an infrared embodiment.

After the features are selected, the feature processing module 236 tracks the features using a feature tracking module 308. In some embodiments, the feature processing module 236 implements an image registration technique to track the features. In some embodiments, two processes are implemented for registration: 1) sequential registration from frame to frame to measure the amount of movement and optionally the velocity of the features (producing a virtual gyro measurement); and, 2) absolute registration from frame to frame to measure positions of features (producing a virtual gimbal resolver measurement).

In some embodiments, the feature processing module 236 also performs an affine compensation step to account for changes in 3D perspective of features. The affine compensation step is a mathematical transform that preserves straight lines and ratios of distances between points lying on a straight line. The affine compensation step is a correction that is performed due to changes in viewing angle that may occur between frames. The step corrects for, for example, translation, rotation and shearing that may occur between frames. The affine transformation is performed at every specified frame (e.g., each 30^{th} frame) when changes in the appearance of the same feature due to 3D perspective becomes noticeable and needs to be corrected for better registration of the feature in the X-Y coordinates of the focal plane.

One embodiment of a registration algorithm is based on correlation of a feature's pixels with local pixels in another frame to find the best matching shift in an X-Y coordinate system which is local to the frame. The method includes trying to minimize the difference between the intensities of the feature pixels in one frame relative to the intensities of the feature pixels in another frame. The method involves identifying the preferred shift (e.g., smallest shift) in a least squares sense. In some embodiments, a feature's local areas are resampled (×3-5) via bicubic interpolation and a finer grid is used for finding the best match. At this stage a simple grid search algorithm is used which minimizes the least-squares (LS) norm between the two resampled images by shifting one with respect to another. In some embodiments, a parabolic local fit of the LS norm surface around the grid-based minimum is performed in order to further improve the accuracy of the global minimum (the best shift in X-Y for image registration). This results in accuracy of about 1/10-th of a pixel or better. The feature tracking and registration can track not only stationary features but also moving features defined on, for example, targets such as cars, trains, or planes.

The feature processing module 236 then smoothes the feature tracks with smoothing module 312 before providing the feature track information to the estimation module 240. Various smoothing algorithms or filters can be employed to perform data smoothing to improve the efficiency of the system and reduce sensitivity to anomalies in the data. In some embodiments, smoothing of features' trajectories is carried out via a Savitzky-Golay filter that performs a local polynomial regression on a series of values in a specified time window (e.g., the position values of the features over a predetermined period of time).

The system includes line of sight measurement module 216 which can also be provided to the estimation module. Line of sight measurement module 216 provides azimuth and elevation measurements to estimation module 240. Optional sensor position measurement module 208 outputs the global-frame three-dimensional position (X, Y, Z) of the aircraft 106 measured by the IMU 108. The position is provided to the estimation module 240. The estimation module 240 receives the feature tracks (local position, movement and velocity data) for the features in the image frames and the output of the sensor position measurement module 208. Both the optional sensor position measurement module 208 and line of sight measurement module 216 provide measurements to the estimation module 240 to be processed by the module 404 (Initialization of Features in 3D) and by the module 416 (Recursive Kalman-Type Filter), both of FIG. 4.

FIG. 4 is a block diagram of exemplary modules used by estimation module 240 in some embodiments. Estimation module 240 includes one or more modules to estimate one or more types of location data (landing site position 220, line of sight data 224 from module 216 and sensor position 228,). In this embodiment, the estimation module 240 includes an initialization module 404, a model generation module 408, a partials calculation module 412, and a recursion module 416. Module 412 outputs the matrix H which is present in Equations 12-14.

The estimation of 3D positions of features as well as estimation of sensor positions and line-of-sight (LOS) is performed by solving a non-linear estimation problem. The estimation module 240 uses feature track information (position, movement and velocity data) for the features in the image frames and the output of the sensor position measurement module 208. The first step in solving the non-linear estimation problem is initialization of the feature positions in 3D (latitude, longitude, altitude). The initialization module 404 does this by finding the feature correspondences in two (or more) frames and then intersecting the lines-of-sights using a least-square fit. When the feature positions are initialized, one can linearize the measurement equations in the vicinity of these initial estimates (reference values). Thereby, the measurements for sensor positions from GPS/INS and LOS are also used as the reference values in the linearization process.

The estimation module 240 implements a dynamic estimation process that processes the incoming data in real time. It is formulated (after linearization) in the form of a recursive Kalman-type filter. The filter is implemented by recursion module 416. Model generation module 408 sets the initial conditions of a linearized dynamic model in accordance with:

ΔX_{Σ}(t+Δt)=Φ(t,Δt)ΔX_{Σ}(t)+F(t)ξ(t) EQN. 1

where t is the time for the current image frame, and Δt is the time step (interval between image frames. A linearized measurement model is then generated in accordance with:

Δy_{Σ}(t)=H(t)Δx_{Σ}(t)+μ(t) EQN. 2

The extended state-vector ΔX_{Σ} comprises the following blocks (all values are presented as deviations of the actual values from their reference ones):

$$\begin{matrix}Δ {X}_{\sum } = [ \frac{Δ p}{Δ s} ] & EQN . 3 \\ Δ p = [ \begin{matrix}Δ {p}_{1} \\ ⋮ \\ Δ {p}_{n}\end{matrix} ] & EQN . 4 \\ Δ {p}_{i}^{stat} = [ \begin{matrix}Δ {x}_{i} \\ Δ {y}_{i} \\ Δ {z}_{i}\end{matrix} ] & EQN . 5 \\ Δ {p}_{i}^{inov} = [ \begin{matrix}Δ {x}_{i} \\ Δ {y}_{i} \\ Δ {z}_{i} \\ Δ {\dot{x}}_{i} \\ Δ {\dot{y}}_{i} \\ Δ {\dot{z}}_{i}\end{matrix} ] & EQN . 6 \\ Δ s = [ \begin{matrix}Δ {x}^{s} \\ Δ {y}^{s} \\ Δ {z}^{s} \\ Δ {α}^{s} \\ Δ {β}^{s} \\ Δ {γ}^{s}\end{matrix} ] & EQN . 7\end{matrix}$$

where Δp is a block that includes all parameters associated with n features and Δs is a block that includes 6 sensor parameters (3 parameters for sensor positions in the absolute coordinate system and 3 parameters for LOS: azimuth, elevation, rotation). Sub-blocks of the block Δp can correspond to stationary (Δpᵢ^{stat}) or moving (Δpᵢ^{mov}) features. Correspondingly, in the first case the sub-bloc includes 3 positions of a feature in 3D (x, y, z); in the second case, the sub-block includes the 3 x-y-z parameters as well as 3 velocities for the moving feature.

The matrix Φ(t, Δt) is the transition matrix that includes the diagonal blocks for features, sensor positions and LOS. Correspondingly, the blocks for the stationary features are unitary matrices of the size [3×3], the blocks for the moving targets are the transition matrices for linear motion [6×6], and the blocks for the sensor's parameters are the scalars corresponding to the 1^{st} order Markov processes. The matrix F(t) is the projection matrix that maps system's disturbances ξ(t) into the space of the state-vector ΔX_{Σ}. The vector of disturbances ξ(t) comprises the Gaussian white noises for the 1^{st} order Markov shaping filters in the equations of moving targets and sensor's parameters (positions and LOS). The vector ξ(t) has the zero mean and the covariance matrix D_{ξ}.

The measurement vector ΔY_{Σ} at each frame includes the following blocks:

$$\begin{matrix}Δ {Y}_{\sum } = [ \begin{matrix}Δ {q}_{1} \\ ⋮ \\ Δ {q}_{n}\end{matrix} ] & EQN . 8 \\ Δ {q}_{i} = [ \frac{Δ {q}_{i}^{VG}}{Δ {q}_{i}^{VGR}} ] & EQN . 9 \\ Δ {q}_{i}^{VG} = [ \frac{Δ {x}_{i}^{VG}}{Δ {y}_{i}^{VGR}} ] & EQN . 10 \\ Δ {q}_{i}^{VGR} = [ \frac{Δ {x}_{i}^{VGR}}{Δ {y}_{i}^{VGR}} ] & EQN . 11\end{matrix}$$

where block Δqᵢ corresponds to the i-th feature (out of n) and comprises the two sub-blocks: 1) Δqᵢ^{VG} which includes two components for the virtual gyro (VG) measurement (feature position); and, 2) Δqᵢ^{VGR} which includes two components for the virtual gimbal resolver (VGR) measurement (feature velocity). In both cases (VG and VGR), the two measurement components are the x and y positions of the features in the focal plane.

In the linearized measurement model, the matrix H(t) is the sensitivity matrix that formalizes how the measurements depend on the state-vector components. The vector η(t) is the measurement noise vector which is assumed to be Gaussian with zero mean and the covariance matrix D_{η}. The measurement noise for the virtual gyro and virtual gimbal resolver is a result of the feature registration errors. In one experiment, the registration errors for one set of data was not Gaussian and were also correlated in time. In some embodiments, for the simplicity of formulating the filtering algorithm, the method involves assuming Gaussian uncorrelated noise in which the variances are large enough to make the system performance robust.

After the dynamics model and measurement models are generated, the estimation module 240 constructs a standard Extended Kalman Filter (EKF) to propagate the estimates of the state-vector and associated covariance matrix in accordance with:

ΔX_{Σ}*(t)=Δ\hat{X}_{Σ}(t)+P*(t)H^{T}(t)D_{η}⁻¹[ΔY_{Σ}(t)−H^{T}(t)Δ\hat{X}_{Σ}(t)] EQN. 12

P*(t)=\hat{P}(t)−\hat{P}(t)H^{T}(t)[D_{η}⁻¹+H(t)\hat{P}(t)H^{T}(t)]⁻¹H(t)\hat{P}(t) EQN. 13

Δ\hat{X}_{Σ}(t+Δt)=Φ(t,Δt)ΔX_{Σ}*(t) EQN. 14

\hat{P}(t+Δt)=Φ(t,Δt)P*(t)Φ^{T}(t,Δt)+F(t)D_{ξ}F^{T}(t) EQN. 14

where, at the processing step of the EKF the a posteriori statistics are generated: ΔX_{Σ}*—the a posteriori estimate of the state-vector ΔX_{Σ}, and P*(t)—the associated a posteriori covariance matrix. Correspondingly, at the prediction step of the EKF the a priori statistics are generated: Δ\hat{X}_{Σ}(t+Δt)—the a priori estimate of the state-vector ΔX_{Σ}, and Δ\hat{P}(t+Δt)—the associated a priori covariance matrix.

The EKF filtering algorithm manages a variable set of features which are being processed from frame to frame. In particular, it adds to the extended state-vector ΔX_{Σ} new features which come into the sensor's field of view and excludes past features that are no longer in the field of view. The features no longer in the field of view are maintained in the filter for some specified time since they continue contributing to the estimation of features in the field of view. This time is determined by the level of reduction in the elements of the covariance matrix diagonal due to accounting for the feature; it is a trade-off between the accuracy in feature locations and the memory speed requirements. The filtering algorithm also manages a large covariance matrix (e.g., the a posteriori matrix P*(t) and the a priori matrix Δ\hat{P}(t+Δt)) in the case of a large number of features, for example, 100-1000's of features). The method maintains correlations in the covariance matrix that have the largest relative effect. The correlations are identified in the process of generating this matrix that is a product of the covariance vector (between each measurement and the state-vector) and the transpose of this vector: P=VV^{T}. The algorithm is based on computing first correlations in the covariance vector and then using a correlation threshold for pair-wise multiplications to identify the essential correlations in the covariance matrix. Selection of the elements in the covariance matrix helps to significantly reduce computational time and memory consumptions by the EKF.

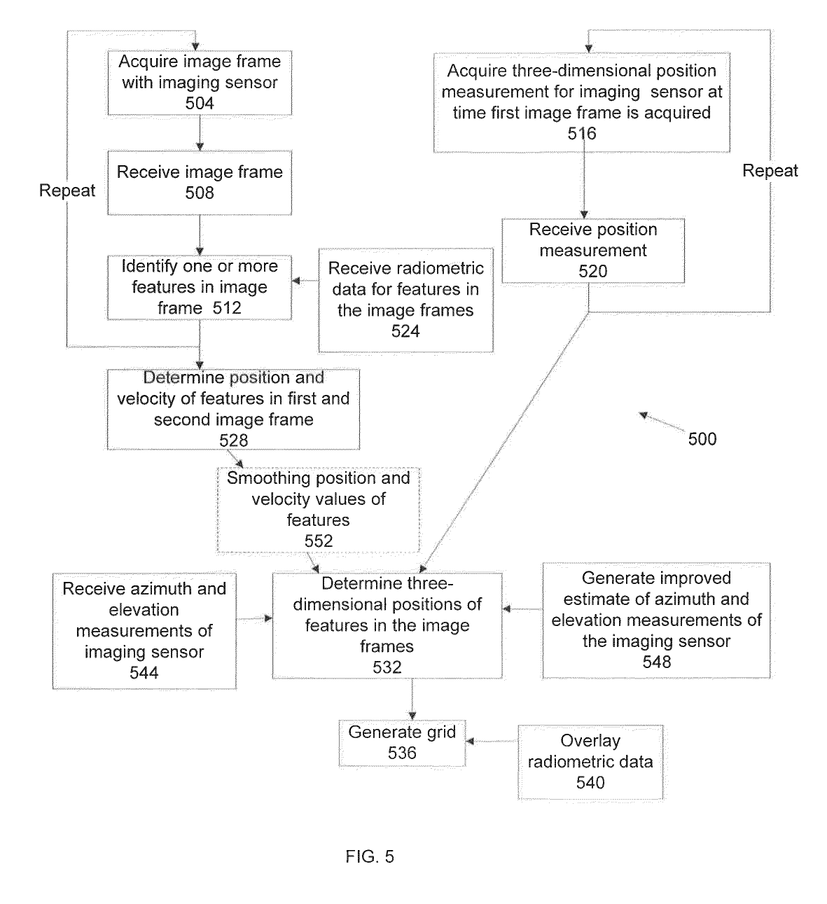

FIG. 5 is a flowchart 500 of a method for locating features in a field of view of an imaging sensor. The method includes acquiring an image frame 504 from the field of view of an imaging sensor at a first time. The acquired image frame is then received 508 by, for example, a processor for further processing. The method then involves identifying one or more features in the image frame 512. The features are identified using any one of a variety of suitable methods (e.g., as described above with respect to FIGS. 2 and 3). The method also includes acquiring a three-dimensional position measurement 516 for the imaging sensor at the first time. The three-dimensional position measurement is acquired relative to an absolute coordinate system (e.g., global X,Y,Z coordinates). The acquired image frame and the acquired position measurement are then received 520 by the processor for further processing. Each of steps 504, 508, 512, 516, and 520 are repeated at least one additional time such that a second image frame and second three-dimensional position measurement are acquired at a second time.

After at least two image frames have been acquired, the method includes determining the position and velocity of features in the image frames 528 using, for example, the feature selection module 304 and tracking module 308 of FIG. 3. The method also includes determining the three-dimensional positions of the features in the image frames 532 based on the position and velocity of the features in the image frames and the three dimensional position measurements for the imaging sensor acquired with respect to step 516. In some embodiments, the position and velocity values of the features are smoothed 552 to reduce measurement errors prior to performing step 532.

In some embodiments, the method includes using azimuth and elevation measurements acquired for the imaging sensor 544 in determining the three-dimensional positions of the features in the image frames. Improved azimuth and elevation measurements can be generated 548 for the imaging sensor based on the three-dimensional positions of the features. This can be accomplished by the algorithms described above since the state-vector includes both three-dimensional coordinates of features and sensor characteristics (its position and the azimuth-elevation of the line of sight). Correspondingly, accurate knowledge of feature positions is directly transferred to accurate knowledge of the sensor position and line of sight.

In some embodiments, the method includes generating a three-dimensional grid 536 over one or more of the image frames based on the three-dimensional positions of features in the image frames. In some embodiments, the three-dimensional grid is constructed by using the features as the cross section of perpendicular lines spanning the field of view of the image frames. In some embodiments, this is done via Delaunay triangulation of the feature positions and then via interpolation of the triangulated surface by a regular latitude-longitude-altitude grid. In some embodiments, the method also includes receiving radiometric data 524 for features in the image frames. The radiometric data (e.g., color of features, optical properties of features) can be acquired when the image frames are acquired.

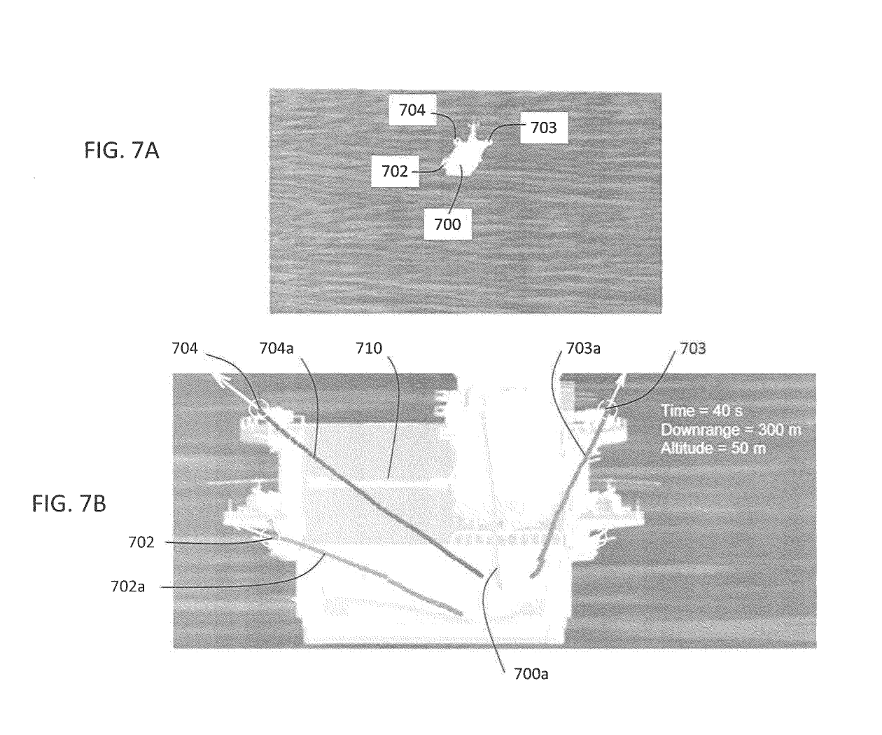

FIGS. 7 A and 7B, show simulated images of an aircraft carrier 700 as seen from an aircraft approaching the carrier for landing. FIG. 7A depicts carrier 700 from 2500 meters away and 300 meters altitude on an initial landing approach. Carrier 700 shows a plurality of features, such as corners 702, 703, 704 which provide clear changes in image intensity. Various other features such as lines and structures may also be identifiable depending upon visibility and lighting conditions. Lighted markers on carrier 700 may also be used as identifiable features. FIG. 7B shows the image of carrier 700 from 300 meters away and 50 meters altitude. Image features such as corners 702, 703, 704 are more well defined. FIG. 7B also shows the movement of corners from their initial relative image grouping 700a to their FIG. 7B positions, by means of lines 702a, 703a, 704a, respectively. Lines 702a, 703a, 704a represent the movement of corners 702, 703, 704 across the local image scale during the approach to carrier 700. The movement of identifiable features over periodic images during landing enables the system to construct a 3D model of carrier 700 and identify a suitable landing area 710 located between the identifiable features.

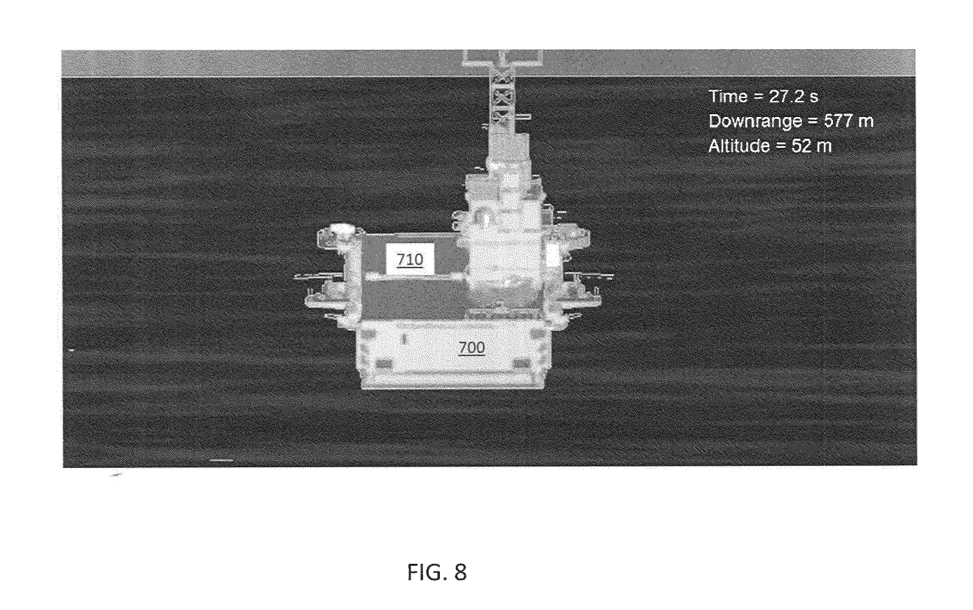

FIG. 8 is another simulated image of carrier 700 superimposed with the highlighted lines of a 3D facet model of the carrier. Landing area 710 is identifiable automatically in the image as being between features of the carrier and an open area free of structure to allow landing of a fixed wing aircraft. A rotary wing aircraft could more readily identify open areas between features for selecting a landing area.

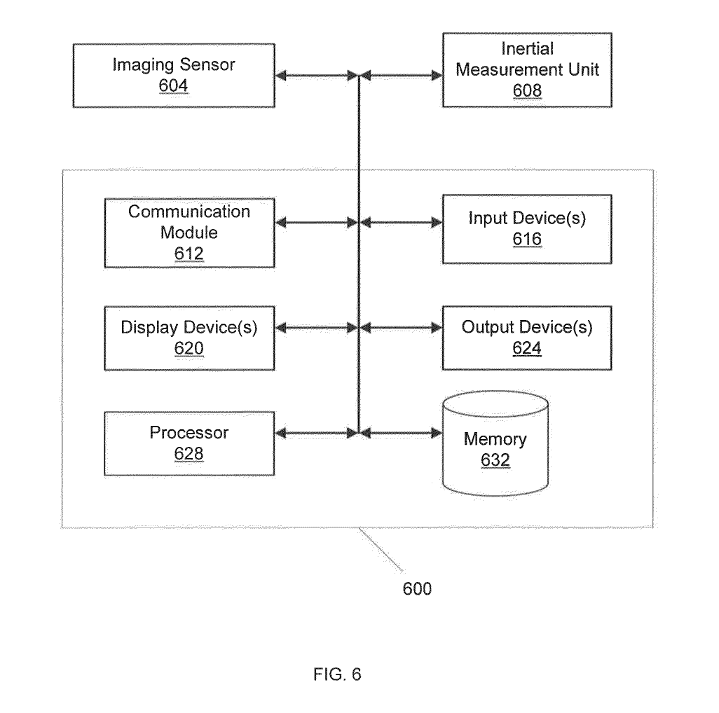

FIG. 6 is a block diagram of a computing device 600 used with a system for locating features in the field of view of an imaging sensor (e.g., system 100 of FIG. 1). The computing device 600 includes one or more input devices 616, one or more output devices 624, one or more display devices(s) 620, one or more processor(s) 628, memory 632, and a communication module 612. The modules and devices described herein can, for example, utilize the processor 628 to execute computer executable instructions and/or the modules and devices described herein can, for example, include their own processor to execute computer executable instructions. It should be understood the computing device 600 can include, for example, other modules, devices, and/or processors known in the art and/or varieties of the described modules, devices, and/or processors.

The communication module 612 includes circuitry and code corresponding to computer instructions that enable the computing device to send/receive signals to/from an imaging sensor 604 (e.g., imaging sensor 104 of FIG. 1) and an inertial measurement unit 608 (e.g., inertial measurement unit 108 of FIG. 1). For example, the communication module 612 provides commands from the processor 628 to the imaging sensor to acquire video data from the field of view of the imaging sensor. The communication module 612 also, for example, receives position data from the inertial measurement unit 608 which can be stored by the memory 632 or otherwise processed by the processor 628.

The input devices 616 receive information from a user (not shown) and/or another computing system (not shown). The input devices 616 can include, for example, a keyboard, a scanner, a microphone, a stylus, a touch sensitive pad or display. The output devices 624 output information associated with the computing device 600 (e.g., information to a printer, information to a speaker, information to a display, for example, graphical representations of information). The processor 628 executes the operating system and/or any other computer executable instructions for the computing device 600 (e.g., executes applications). The memory 632 stores a variety of information/data, including profiles used by the computing device 600 to specify how the spectrometry system should process light coming into the system for imaging. The memory 632 can include, for example, long-term storage, such as a hard drive, a tape storage device, or flash memory; short-term storage, such as a random access memory, or a graphics memory; and/or any other type of computer readable storage.

The above-described systems and methods can be implemented in digital electronic circuitry, in computer hardware, firmware, and/or software. The implementation can be as a computer program product that is tangibly embodied in non-transitory memory device. The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors, or one or more servers that include one or more processors, that execute a computer program to perform functions of the disclosure by operating on input data and generating output. Method steps can also be performed by, and an apparatus can be implemented as, special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data. Magnetic disks, magneto-optical disks, or optical disks are examples of such storage devices.

Data transmission and instructions can occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A method, implemented in a computer, of controlling landing of an aircraft, the computer comprising a processor and a memory configured to store a plurality of instructions executable by the processor to implement the method, the method comprising:
receiving multiple sequential frames of image data of a landing site from an electro-optic sensor on the aircraft;
identifying a plurality of features of the landing site in the received multiple sequential frames of image data;
calculating changes in relative position and distance data between the identified plurality of features over multiple sequential frames of image data using a local coordinate system within the received multiple frames of image data;
providing a mathematical 3D model of the landing site as a function of the calculated changes in relative position and distance data between the identified plurality of features over the multiple sequential frames of image data;
updating the 3D model by periodically repeating the steps of receiving frames, identifying features, and calculating changes during approach to the landing site by the aircraft;
identifying a landing area in a portion of the 3D model of the landing site;
generating aircraft flight control signals, as a function of the updated 3D model and the identified landing area, for controlling the aircraft to land on the identified landing area; and
landing the aircraft on the landing area using the generated aircraft flight control signals.

2. (canceled)

3. The method of claim 1, wherein identifying a landing area uses previously known information about the landing site.

4. The method of claim 1, further comprising receiving azimuth and elevation data of the electro-optic sensor relative to the landing site and using the received azimuth and elevation data in calculating relative position and distance data and in generating the aircraft flight control signals.

5. The method of claim 1, wherein the landing area is identified between identified image features.

6. The method of claim 1, wherein generating aircraft flight control signals provides distance and elevation information between the aircraft and the landing area.

7. The method of claim 6, wherein generating aircraft flight control signals provides direction and relative velocity information between the aircraft and the landing area.

8. The method of claim 1, further comprising using calculated relative position and distance data from multiple sequential frames of image data to determine time remaining for the aircraft to reach the landing area.

9. The method of claim 1, further comprising measuring relative two dimensional positional movement of identified features between multiple sequential image frames to determine any oscillatory relative movement of the landing site.

10. The method of claim 1, wherein the received sequential frames of image data includes a relative time of image capture.

11. The method of claim 1, further comprising initially locating and identifying the landing site as a function of geo-location information.

12. The method of claim 11, further comprising positioning the aircraft on a final approach path as a function of the geo-location information.

13. The method of claim 1, further comprising receiving sequential frames of image data of the landing site from different angular positions relative to the landing site.

14. (canceled)

15. (canceled)

16. The method of claim 1, further comprising transmitting 3D model data to a remote pilot during approach to the landing site.

17. The method of claim 1, further comprising providing the aircraft control signals to an autopilot control system.

18. A system for controlling landing of an aircraft, comprising:
an electro-optic sensor;
a processor coupled to receive multiple sequential frames of image data from the electro-optic sensor; and
a memory, the memory including code representing instructions that, when executed by the processor, cause the processor to:
receive multiple sequential frames of image data of a landing site from the electro-optic sensor;
identify a plurality of features of the landing site in the received multiple sequential frames of image data;
calculate changes in relative position and distance data between the identified plurality of features over multiple sequential frames of image data using a local coordinate system within the received multiple frames of image data;
provide a mathematical 3D model of the landing site as a function of the calculated changes in relative position and distance data between the identified plurality of features over the multiple sequential frames of image data;
update the 3D model by periodically repeating the steps of receiving frames, identifying features, and calculating changes during approach to the landing site;
identify a landing area in a portion of the 3D model of the landing site;
generate aircraft flight control signals, as a function of the updated 3D model and the identified landing area, for controlling the aircraft to land on the identified landing area; and
land the aircraft on the landing area using the generated aircraft flight control signals.

19. (canceled)

20. The system of claim 18, wherein the memory includes code representing instructions that when executed cause the processor to receive azimuth and elevation data of the electro-optic sensor relative to the landing site and use the received azimuth and elevation data in calculating relative position and distance data to generate the aircraft flight control signals.

21. The system of claim 18, wherein the memory includes code representing instructions that when executed cause the processor to identify the landing area between identified image features.

22. The system of claim 18, wherein the memory includes code representing instructions that when executed cause the processor to measure relative two dimensional positional movement of identified features between multiple sequential image frames to determine any oscillatory relative movement of the landing site.

23. (canceled)

24. (canceled)
